(19) United States
(12) Patent Application Publication
(10) Pub. No.: US 2017/0057248 A1
(43) Pub. Date: Mar. 2, 2017

(54) COLD TRANSFER OF A DYE-BASED INKJET IMAGE TO WET POLYQUATERNIUM-10-TREATED FABRICS

(71) Applicant: BROTHER INTERNATIONAL CORPORATION, Bridgewater, NJ (US)

(72) Inventor: Kangning LIANG, Bartlett, TN (US)

(73) Assignee: BROTHER INTERNATIONAL CORPORATION, Bridgewater, NJ (US)

(21) Appl. No.: 14/843,190

(22) Filed: Sep. 2, 2015

(51) Int. Cl. B41J 3/407; B41J 2/005

(52) U.S. Cl. CPC B41J 3/4078; B41J 2/0057

(57) ABSTRACT

Embodiments of the invention enable users to personalize fabric objects of varying shapes and sizes, such as, e.g., garments, fabric sheets, bags, etc. An inkjet printer, using conventional inks, may print an image on a prepared image transfer sheet, which may be, for example, a plastic backing sheet coated with a polymer layer. Then, with a water-based formulation applied to the fabric, the image may conveniently be transferred from the image transfer sheet to the fabric, e.g., at room temperature.

### BACKGROUND

People often want to personalize fabric objects, e.g., by applying custom images to them. But for most consumers, their options for doing this are limited and often unsatisfactory.

For example, inkjet and laser printers can conveniently print images and may be common in homes and businesses. But a typical ink jet or laser printer may be unable to print directly on a fabric object such as, e.g., a T-shirt. Conventionally, therefore, transfer of an image to a fabric involves printing the image onto a transfer sheet and then transferring the image from the sheet to the fabric.

One kind of conventional transfer sheet, for example, is iron-on transfer paper, which may be coated with a heat-sensitive plastic film. A conventional ink jet printer may print an image on the film, and then a clothes iron is used to transfer the film (with the image) onto the fabric. But the use of a plastic film results in fabric that looks and feels like plastic.

Alternatively, a dye-sublimation image transfer sheet may be used. A dye-sublimation printer prints an image onto a dye-sublimation image transfer sheet. But a heat press is required to transfer the image to the fabric, and dye-sublimation printers and dyes are relatively expensive and uncommon.

Yet another alternative is use of organic solvents to transfer a laser-printed image to a fabric. Although this transfer can occur at room temperature, it is tedious, and the use of an organic solvent may raise health and environmental concerns. Further, this method is suitable only for transferring images that are formed out of laser printer toner.

What is needed, therefore, is a safe and convenient way to create an image using a conventional ink jet printer and to apply that image to a fabric object.

### BRIEF SUMMARY

Embodiments of the invention enable users to personalize fabric objects of varying shapes and sizes, such as, e.g., garments, fabric sheets, bags, etc. According to embodiments, an inkjet printer, using conventional inks, may print an image on a prepared image transfer sheet. Then, with a water-based formulation applied to the fabric, the image may conveniently be transferred from the image transfer sheet to the fabric, e.g., at room temperature.

According to an embodiment of the invention, a method of transferring an inkjet image to a fabric substrate comprises printing the image in reverse onto a portion of an image transfer sheet that comprises a backing sheet; applying a solution, in which water is a solvent, and which comprises a binding and anchoring agent, to the fabric substrate; placing the portion of the image transfer sheet onto which the image in reverse has been printed in contact with the fabric substrate; and removing the backing sheet.

In an embodiment of the invention, the transfer of the image takes place at room temperature.

In an embodiment of the invention, the portion of the image transfer sheet that bears the image is placed in contact with the fabric substrate at a time when the fabric substrate remains wet from the application of the solution that comprises the binding and anchoring agent. Alternatively, in an embodiment of the invention, the fabric substrate is allowed to dry following application of the binding and anchoring agent, and it is rewetted with water before being placed in contact with the portion of the image transfer sheet that bears the image.

In embodiments of the invention, the binding and anchoring agent is PQ-10. In an embodiment of the invention, the solvent contains a 1.35% concentration of PQ-10. In embodiments of the invention, the image transfer sheet comprises a layer of PVP applied to a PET backing sheet.

According to an embodiment of the invention, a printable image transfer sheet is provided for receiving an inkjet image and transferring the inkjet image to a prepared fabric substrate. The image transfer sheet comprises a PET backing sheet coated with a layer of PVP.

According to embodiments of the invention, a fabric object is provided that is capable of permanently receiving an inkjet image through contact with an image transfer sheet upon which the image has been printed. At least a portion of the object has been impregnated with a water-soluble binding and anchoring agent; and the binding and anchoring agent, when wetted with water, is capable of binding to dye molecules within the image and anchoring them to the fabric substrate in a water-resistant manner. In an embodiment of the invention, the binding and anchoring agent is polyquaternium-10.

### BRIEF DESCRIPTION OF THE DRAWINGS

The invention is illustrated in the figures of the accompanying drawings, which are meant to be exemplary and not limiting, and in which like references are intended to refer to like or corresponding things.

FIGS. 1a, 1b, and 1c depict conceptually image transfer to a fabric substrate according to embodiments of the invention.

FIG. 2 depicts a process for transferring an image according to an embodiment of the invention.

### DETAILED DESCRIPTION OF THE PREFERRED EMBODIMENTS

According to embodiments of the invention, an inkjet printer may print an image on an image transfer sheet designed for that purpose. A water-based formulation including a binding and anchoring agent may be applied to a fabric object (e.g., a T-shirt) to prepare the object to receive the image. While the fabric is wet, the image-bearing side of the image transfer sheet may be placed in contract with a treated portion of the fabric to transfer the image. After sufficient dyes have transferred from the sheet to the fabric, the sheet may be removed, and the fabric may permanently bear the image. Fabrics made of cotton, cotton-polyester blend, polyester, and silk can be used as image-receiving substrates.

Embodiments of the invention may take advantage of chemical properties of common inkjet inks and their components. Although printer manufacturers may specially formulate and tailor inks to their printers, many common inks share some properties. As is known in the art, dye-based aqueous inkjet inks commonly include water-soluble dyes that contain multiple sulfonate and/or carboxylate groups, which dissociate in water to carry negative charges. When a proper counterion (cation) is present, these dyes can react with the cation to form a salt that is insoluble in water. If the cation is connected or bound to a substrate, then binding the dyes to the cation may permanently fix the dyes on the substrate, forming on the substrate an inkjet image that is durable and water-resistant.

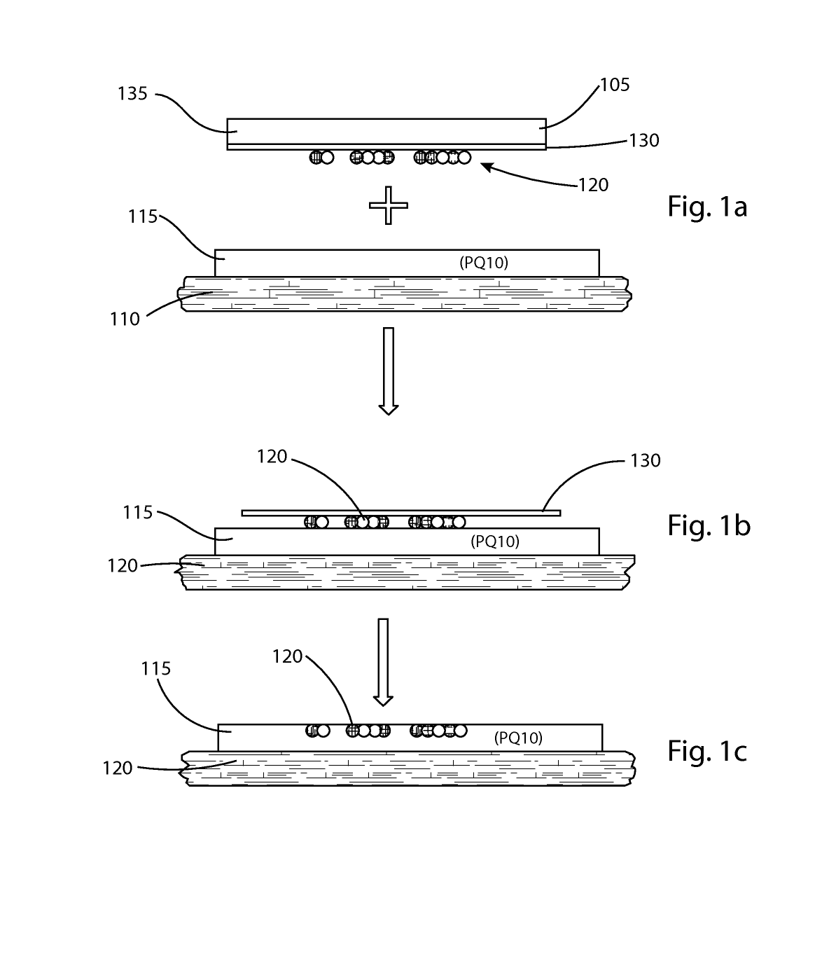

FIGS. 1a, 1b, and 1c depict conceptually an image transfer sheet 105 (bearing an image) and a fabric object 110 that includes a region 115 that has been treated with a binding and anchoring agent, e.g., according to embodiments of the invention.

The image on the image transfer sheet is made of dye molecules 120 that bear negative charges when dissolved in water. These dyes, containing sulfonate groups, carboxylate groups, or both, can react with a proper counterion (cation) to form a water-insoluble salt. A great many organic cations, such as, e.g., quaternary ammonium and pyridinium, are known to react with these dyes to form water-insoluble salts.

Embodiments of the invention may take advantage of these properties. For example, when a fabric object 110 has been treated with a binding and anchoring agent that includes a cationic polymer, direct contact between an inkjet image formed from the dyes and the treated area 115 can let the dyes 120 migrate into the treated region 115 and bond to the cations, thereby forming a horizontally-flipped version of the original image on the image receptive layer 115.

According to embodiments of the invention, a cellulose-based cationic material, polyquaternium-10 (PQ-10), may be used as a binding and anchoring agent to immobilize inkjet dyes on fabric substrates. PQ-10 is a linear molecule with many hydroxyl groups attached to the backbone. It thus supplies cations that can react with the inkjet dyes, and it also can form a network of hydrogen bonds with polar fabric substrates made of cotton (cellulose), polyester, and wools. The combination of the dyes' reactions with cations on PQ-10 and the strong hydrogen bonding interaction between PQ-10 and a fabric substrate leads to a unique composite system, dyes-PQ-10-substrate, in which PQ-10 both anchors the dyes and binds to the substrate. PQ-10 may further be advantageous in connection with embodiments of the invention because it is water-soluble and sufficiently non-toxic to be a common ingredient in commercial hair care products.

An image for transfer to a fabric substrate according to embodiments of the invention may first be printed on an image transfer sheet. Transferring the image may involve placing the image-bearing surface of the image transfer sheet in contact with the treated fabric substrate. Because this transfer is based on the migration of dyes from an image transfer sheet to the substrate surface, an image transfer sheet according to embodiments of the invention may have a surface that does not strongly bind to the dyes so that the dyes may move freely under image-transferring conditions.

It has been determined, for example, that an image transfer sheet comprising a printable layer of poly(vinyl pyrrolidone) (PVP) on a plastic support sheet (for example, polyethylene terephthalate (PET)) can be used in embodiments of the invention to form high quality images. The transfer is in fact enhanced by the water solubility of PVP.

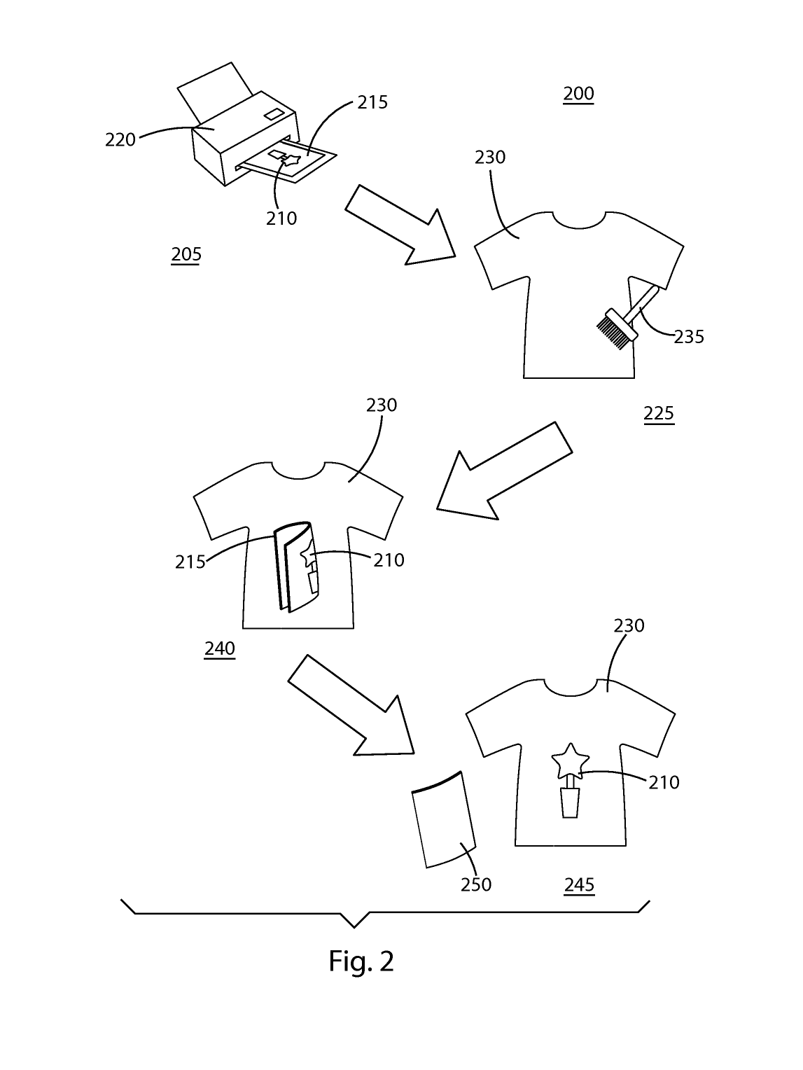

FIG. 2 depicts steps of transferring 200 an inkjet image to a fabric substrate according to an exemplary embodiment of the invention. As depicted, a process for a cold image transfer begins in step 205 with printing the image 210 onto a PVP image transfer sheet 215 using a conventional inkjet printer 220. Such an image transfer sheet 215 may be prepared, e.g., by coating one side of a PET sheet with a 20% PVP solution. For example, a PET sheet may be rod-coated with a PVP solution to form a layer that is thick enough to fully absorb the inks of the image: according to embodiments of the invention, a suitable layer of PVP may be between 5 microns and 200 microns thick, and preferably between 20 microns and 100 microns.

It will be appreciated that the dimensions of the PET sheet may conveniently be chosen to be similar to dimensions of a standard sheet of paper (e.g., 8½″×11″ or ISO A4), and the thickness of sheet may be such that, when coated with a layer of PVP, the sheet may still pass through a typical printer's feed path without problems (e.g., jamming).

After the PVP solution dries, a desired image 210 may be printed onto the PVP surface of the image transfer sheet 215, e.g., using a conventional inkjet printer 220 such as a Brother® MFC-J6710DW. If desired, any unwanted portion of the image sheet 215 can be trimmed away (not pictured) before its use for image transfer.

In step 225, a fabric substrate 230 is prepared for image transfer according to an embodiment of the invention. This preparation may involve applying a PQ-10 solution onto the fabric substrate 230, where, as discussed above, PQ-10 acts as both a dye anchor and a binder to the fabric material. For example, a 1.35% PQ-10 solution may be spread across the fabric substrate 230 using a glass rod or a brush 235, which prepares the fabric 230 to receive the dyes from the ink jet image.

A commercially available preparation that may be suitable for treating a fabric substrate, according to an embodiment of the invention, is UCARE™ Polymer JR-30M, sold by Dow® Personal Care. This product may be supplied, e.g., as a powder, and a solution in connection with an embodiment of the invention may be prepared, e.g., in a lab or factory, by mixing the powder with water or another solvent. According to one embodiment of the invention, the concentration of PQ-10 in the solution is 1.35%, although acceptable concentrations, according to embodiments of the invention, may range from 0.2% to 2%, and a preferred range may be from 1% to 1.5%.

As is known in the art, an aqueous solution of PQ-10 may be more viscous than water and that the viscosity may depend upon the concentration of PQ-10. It will be appreciated that a viscous aqueous solution of PQ-10 may be preferred in connection with embodiments of the invention, as the increased viscosity of the solution may ease application of the preparation to the fabric substrate, e.g., with a brush or glass rod. It may also minimize lateral diffusion of dyes during image transfer, helping maintain a crisp image.

It is further known in the art that PQ-10 is available in varying grades, with the different grades having, e.g., differently-sized molecules of PQ-10. For example, Dow® supplies grades of PQ-10 designated, e.g., JR-125 and JR-400, which have smaller molecules that the JR-30M referred to above. These other two grades may form less viscous solutions at a concentration of 1.35% than JR-30M does. Although the concentration of the solution may be increased when using these other grades (e.g., to within a range of 2% to 10%), it will be appreciated that the resulting image on the fabric substrate could be less water resistant than one formed using JR-30M.

The transfer of image to a fabric takes place under ambient conditions and in the presence of water acting as a vehicle for dye movements. When an image transfer sheet is in contact with wet substrate, dyes of the image dissolve into water and subsequently migrate across the interface onto the fabric substrate, where the PQ 10 and dye molecules react together.

In step 240, the image-bearing side of the image transfer sheet 215 may be applied to the wet PQ-10-laden fabric 230. This step preferably occurs right after the fabric substrate 230 has been fully wetted with the PQ-10 solution. To ensure a complete transfer, the image transfer sheet may be pressed gently against the fabric substrate 230 to maintain the contact between them for some period to ensure complete transfer, but the transfer can take place at room temperature. It will be appreciated that the time required to achieve an acceptable transfer may depend, e.g., on a subjective determination of what result is acceptable, but a generally satisfactory transfer has been found to take place after 1 to 5 minutes of contact between the image transfer sheet and the fabric substrate.

It will be appreciated that the image appearing on the fabric 230 may be a mirror image of the image 210 deposited on the image transfer sheet 215.

In step 245, the backing 250 of the image transfer sheet 215 is removed, and the fabric 230 dries. If desired, the fabric 230 bearing the transferred image can be gently washed in cold water after it is dry to remove excess PQ-10 and any PVP left on the fabric from the image transfer sheet 215.

As depicted, the image transfer occurs immediately after applying the PQ-10 solution to the fabric substrate. Alternatively, according to an embodiment of the invention, the fabric may be prepared ahead of time with a PQ-10 solution that is dried before transferring an image. Then, immediately before an image is transferred to it, the fabric is dampened with water, e.g., by spraying a controlled amount of water over it. (A “controlled” amount of water may be, e.g., enough water to thoroughly dampen the fabric, but not so much that water drips from fabric if it is gently squeezed; the aim is to dampen the fabric sufficiently to allow image transfer without adding so much water that the inks diffuse appreciably during transfer, which would blur the image.)

The image transfer sheet is gently pressed against the fabric for some time to allow the transfer of the image to take place. After the transfer, the backing of the image transfer sheet is removed and the transferred image is dried. As before, after drying, the image may be gently washed in cold water to remove excess PQ-10 and any PVP left on the fabric from the image transfer sheet.

The description of the claimed invention in terms of certain embodiments is meant to be illustrative, not limiting. It will be appreciated by those skilled in the relevant arts that the principles of the invention apply to many variations of the described methods and materials. The scope of the invention is therefore expressed by the claims below and not limited by any particular embodiment in this description.

I claim:

1. A method of transferring an inkjet image to a fabric substrate, the method comprising:
printing the image in reverse onto a portion of an image transfer sheet that comprises a backing sheet;
applying a solution, in which water is a solvent and which comprises a water-soluble binding and anchoring agent, to the fabric substrate;
placing the portion of the image transfer sheet onto which the image in reverse has been printed in contact with the fabric substrate; and
removing the backing sheet.

2. The method of claim 1, wherein the transfer of the image takes place at room temperature.

3. The method of claim 1, wherein the portion of the image transfer sheet is placed in contact with the fabric substrate at a time when the fabric substrate remains wet from the application of the solution that comprises the binding and anchoring agent.

4. The method of claim 1, comprising:
after applying the solution that comprises the binding and anchoring agent to the fabric substrate, but before placing the fabric substrate in contact with the portion of the image transfer sheet, allowing the fabric substrate to dry; and
after the fabric substrate has been allowed to dry, but before placing the fabric substrate in contact with the portion of the image transfer sheet, applying water to the fabric substrate.

5. The method of claim 1, wherein the binding and anchoring agent is PQ-10.

6. The method of claim 5, wherein the solvent contains a 1.35% concentration of PQ-10.

7. The method of claim 1, wherein the image transfer sheet comprises a layer of PVP applied to a PET backing sheet.

8. A printable image transfer sheet for receiving an inkjet image and transferring the inkjet image to a prepared fabric substrate, the image transfer sheet comprises a PET backing sheet coated with a layer of PVP.

9. A fabric object capable of permanently receiving an inkjet image through contact with an image transfer sheet upon which the image has been printed, wherein:
at least a portion of the object has been impregnated with a water-soluble binding and anchoring agent; and
the binding and anchoring agent, when wetted with water, is capable of binding to dye molecules within the image and anchoring them to the fabric substrate in a water-resistant manner.

10. The fabric object of claim 9, wherein the binding and anchoring agent is polyquaternium-10.
